(19) United States
(12) Patent Application Publication
(10) Pub. No.: US 2025/0359970 A1
(43) Pub. Date: Nov. 27, 2025

(54) Alveolar and Maxilla distraction osteogenesis for dental implant treatments of the vertical bone atrophy

(71) Applicant: Felix Langer, Glendale, NY (US)

(72) Inventor: Felix Langer, Glendale, NY (US)

(21) Appl. No.: 18/671,807

(22) Filed: May 22, 2024

(51) Int. Cl. A61C 8/02

(52) U.S. Cl. CPC A61C 8/0006

(57) ABSTRACT

The present invention pertains to devices and methods for distraction osteogenesis, with a particular focus on distraction devices and systems used to treat mandibular or maxillary alveolar ridge atrophy. It also includes methods for using these devices or systems for bone tensioning.

### FIELD OF THE INVENTION

The present invention pertains to devices and methods for distraction osteogenesis, specifically focusing on distraction devices and systems used to treat mandibular or maxillary alveolar ridge atrophy. Additionally, it includes methods for using these devices or systems for bone lengthening.

### BACKGROUND OF THE INVENTION

Mandibular or maxillary alveolar ridge atrophy is a well-known pathology that can develop slowly following tooth loss or acutely due to factors such as infection, cyst removal, traumatic tooth extraction, tumor resection, or trauma. Adequate alveolar ridge volume is crucial for the placement of dental implants. The placement and long-term prognosis of dental implants primarily depend on the size of the implants, the ratio between the implants and the attached prosthesis, and their spatial location relative to the intra-jaw teeth and opposed jaw occlusion. In some cases, short dental implants can be used as a compromise to overcome alveolar ridge atrophy, but most cases require a reconstructive phase before implant placement.

Several surgical procedures exist to address alveolar ridge atrophy, varying with the severity of the condition. Mild atrophy can be managed with guided tissue regeneration, while intermediate and severe atrophy often necessitate bone grafts or bone lengthening. The severity of atrophy determines the volume of the required bone graft and the appropriate grafting technique and materials. Since achieving soft tissue coverage without tension across the entire graft is crucial and limits the volume of augmentation, vertical atrophy presents the greatest challenge. As vertical atrophy increases, achieving predictable soft tissue coverage becomes more difficult.

Severe cases of alveolar ridge atrophy that cannot be reliably treated with bone grafts have, over the past two decades, been addressed with the surgical technique of bone lengthening referred to as distraction osteogenesis. This technique involves applying gradual, controlled tension forces to an osteotomized bone segment to achieve bone lengthening. Unlike traditional methods, distraction osteogenesis simultaneously expands the soft tissue envelope, effectively eliminating any limit to bone gain. This technique has become a vital tool for reconstructive surgeons.

Most alveolar distractors consist of two attachment plates and a drive rod that either connects or separates them. The plates anchor the device to the basal bone and the osteotomized bone segment, while the rod applies tension forces to both segments, thereby distracting the movable segment. Anchoring the device requires at least 5 mm of vertical basal bone length and a similar length for the osteotomized segment, due to the dimensions of the attachment plates and bone screws. In the posterior mandible, where the inferior alveolar nerve is located, careful placement of bone screws through the buccal cortex is necessary to avoid nerve damage. Similarly, anchoring the device in the posterior maxilla can be challenging due to the thin bony wall of the maxillary sinus, which can compromise device stability.

These risks and limitations often deter patients from opting for distraction osteogenesis, even though they may have no other reconstructive options. On the other hand, patients who have not experienced previous extreme traumatic events, such as the resection of a benign tumor or trauma, often lack the motivation to undergo a major surgical procedure and confront the relevant risks. Additionally, motivation is further reduced by the fact that removing the distraction appliance necessitates a second surgical procedure, resulting in additional discomfort.

These limitations and challenges highlight the need for a different approach to bone gain via distraction osteogenesis. Key considerations, such as reducing the risk to the inferior alveolar nerve when anchoring the lower bone plate and avoiding inadequate stability when placing a bone plate near the maxillary sinus, indicate that the anchoring of the distraction device must be achieved through alternative methods.

Several patents have attempted to address these issues but with notable drawbacks. For instance, Patent Application Publication Number US 2005/0084822 A1, dated Apr. 21, 2005, proposed a combination of a dental implant and distractor to facilitate distraction osteogenesis. However, this approach has several disadvantages. First, activating the distraction bolt by turning can cause rotational movement of the osteotomized segment, which should be avoided. Additionally, after vertical movement once or twice a day, the osteotomized segment must remain stable to allow stem cells to create new bone tissue. If the segment is not stabilized, bone tissue will not form properly. The soft gum tissue covering the bone segment might not be sufficient to support its fixed position.

Similar issues apply to U.S. Pat. No. 11,771,468B2, dated Oct. 3, 2023, and Public Application Number US 0020052608 A1, dated May 2, 2002. These problems underscore the need for a revised approach to distraction osteogenesis.

### SUMMARY OF THE INVENTION

The following embodiments and aspects are described and illustrated in conjunction with systems, devices, and methods intended to be exemplary and illustrative, not restrictive in scope. Various embodiments address and mitigate one or more of the aforementioned issues, while others offer additional advantages or improvements.

Some embodiments provide devices, systems, and methods for performing distraction osteogenesis. A crestal osteotomy line is created in a way that avoids damaging the alveolar nerve, separating the osteotomized bone segment from the remaining basal bone of the mandible. Two or more holes, with diameters between 2 to 3.5 mm, should be drilled through the osteotomized bone segment ending at crestal osteotomy line. These holes should be drilled in locations where implants will eventually be installed; with diameters smaller than the implants to be placed after the alveolar ridge atrophy is corrected, allowing each hole to be used twice. After drilling, all holes should be threaded according to specific parameters for the designated bolts.

One hole should be drilled in the center of the osteotomized bone segment, extending into the remaining basal bone no more than 2 mm, to ensure a secure connection. The hole should be threaded to the size of the designated bolt. The purpose of this central hole differs from that of the other drilled holes, which do not extend into the basal bone. The central hole, which extends into the basal bone, is designed to accommodate a bolt that will connect the osteotomized bone segment to the remaining basal bone, ensuring the segment is not pulled away during the healing process. Throughout this period, specialized stem cells will generate a new bone structure, and it is crucial to provide system's stability preventing any movement to allow proper bone formation.

After creating the crestal osteotomy line, a waiting period of approximately seven days should precede the distraction process. In order to secure the position between the osteotomized bone segment and remaining basal bone, a small nut should be placed at the end of the central bolt on top of the segment. During distraction, the osteotomized bone segment should be moved upwards once or twice daily, approximately 0.5 to 1 mm per 24 hours. The distraction process is facilitated by two or more distraction bolts that push against the basal bone through threaded holes in the osteotomized segment. Just before each movement, the small nut holding the osteotomized bone segment in place should be temporarily loosened, then retightened after the movement to a new position, about 0.25 to 0.5 mm different from the previous position.

To prevent the rotation of the osteotomized bone segment during distraction, it is essential to use two bolts with opposite threading directions (one right-turning and the other left-turning), ensuring upward movement without rotation. By activating both at the same time, the osteotomized bone segment will be moving directly upwards without any rotational moves.

For patients with lower bone density, an additional device, such as a titanium or stainless steel sleeve threaded internally and externally, may be inserted instead of simply drilling a threaded hole for bolts that provide the move of the osteotomized bone segment against basal bone. After completing the distraction process, the sleeve and all bolts are removed, preparing the patient for implant placement to replace missing teeth.

### BRIEF DESCRIPTION OF THE FIGURES

Some embodiments of the invention are described here with reference to the accompanying figures. The description, along with the figures, demonstrates to someone with an ordinary skill in the art how these embodiments can be practiced. The figures are meant for illustrative purposes and do not attempt to show structural details beyond what is necessary for a basic understanding of the invention. For clarity, some objects in the figures are not shown to scale.

### IN THE FIGURES

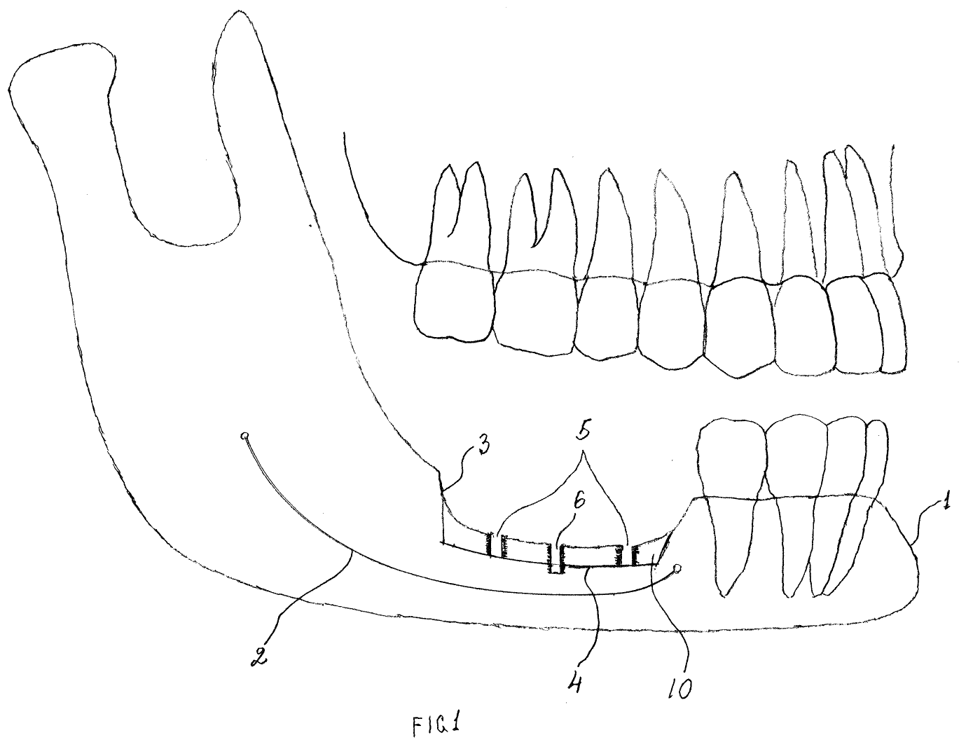

FIG. 1 shows a side view of the mandible, highlighting the atrophy on the alveolar ridge, the crestal osteotomy line, the osteotomized bone segment, and the predrilled threaded holes.

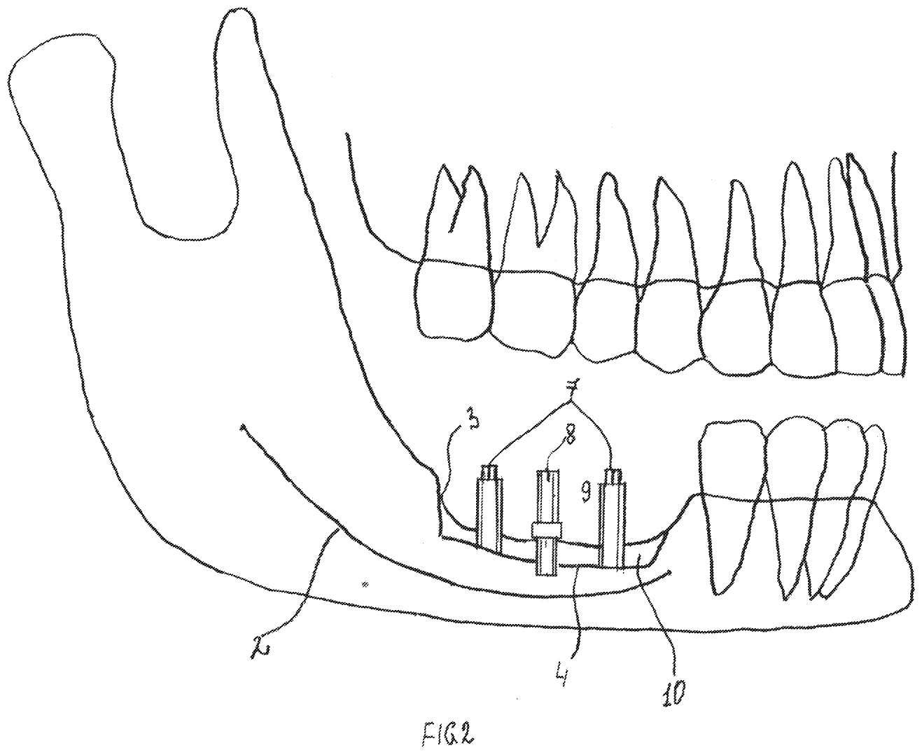

FIG. 2 shows a side view of the mandible from FIG. 1, prior to the commencement of distraction, featuring two bolts installed—one with a right-hand thread and the other with a left-hand thread—and a central bolt connecting the basal bone to the osteotomized bone segment.

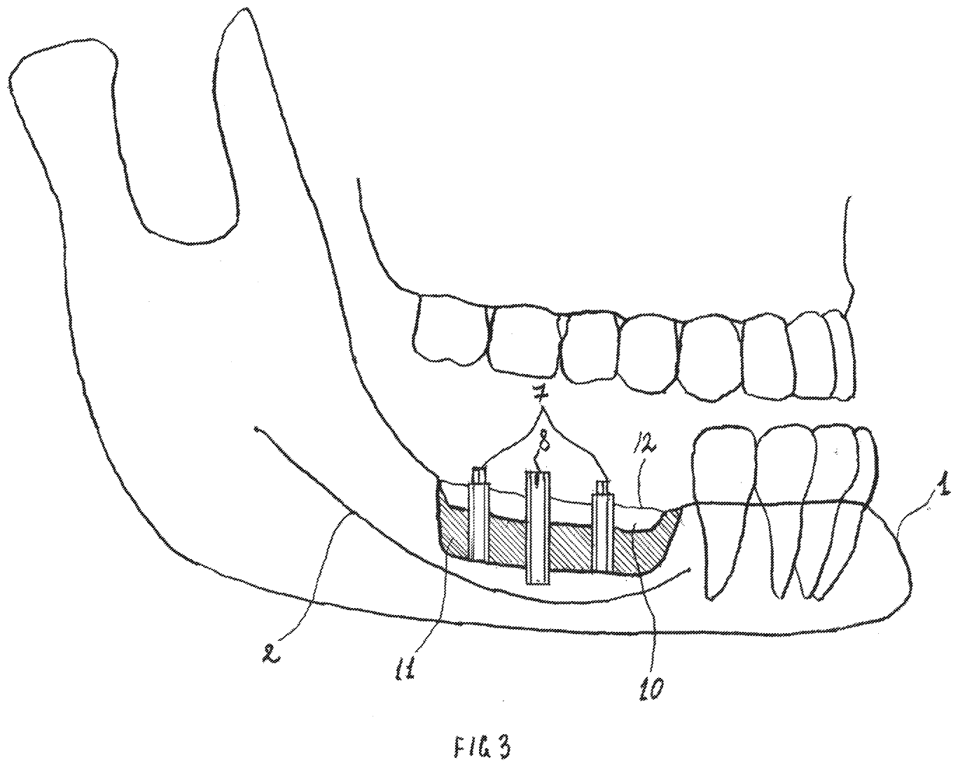

FIG. 3 illustrates a side view of the mandible from FIG. 2 after the distraction process is complete, with the alveolar ridge raised to the correct position to receive normal dental implants.

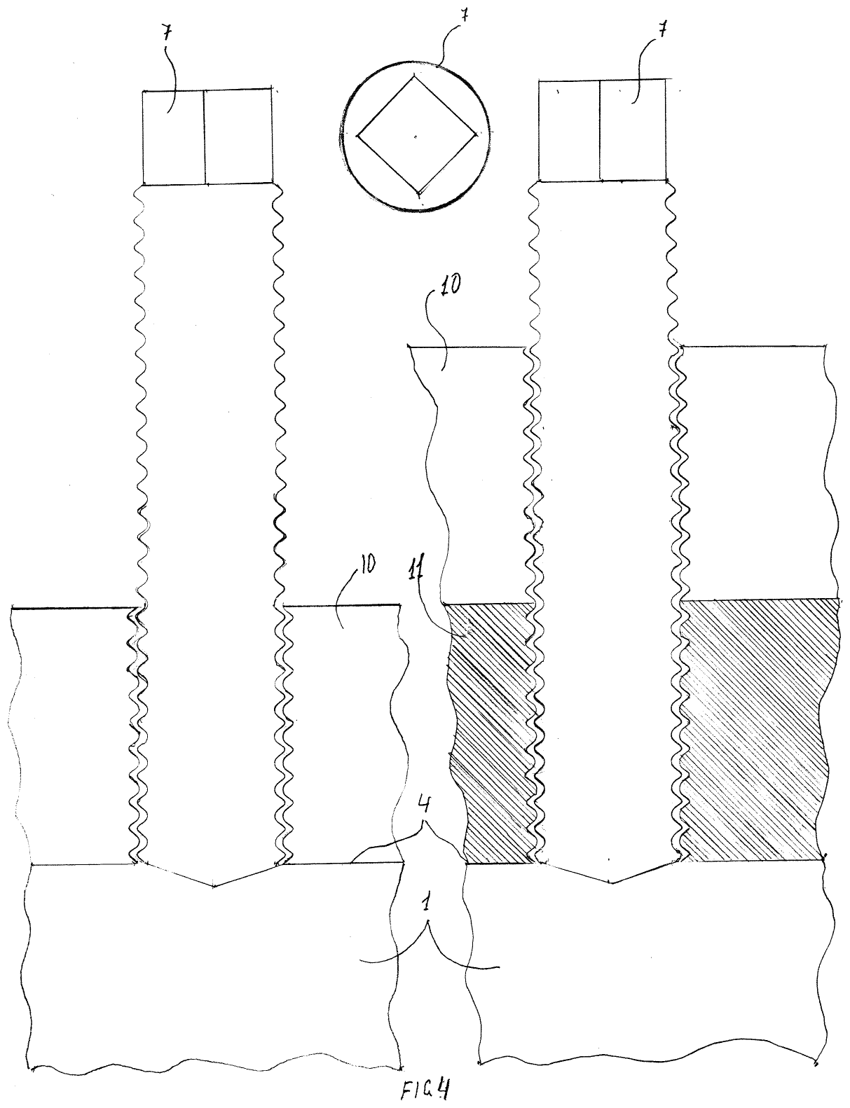

FIG. 4 provides a magnified cross-sectional view of the distraction site before and after the distraction process, including the distraction bolt and a top view projection of it.

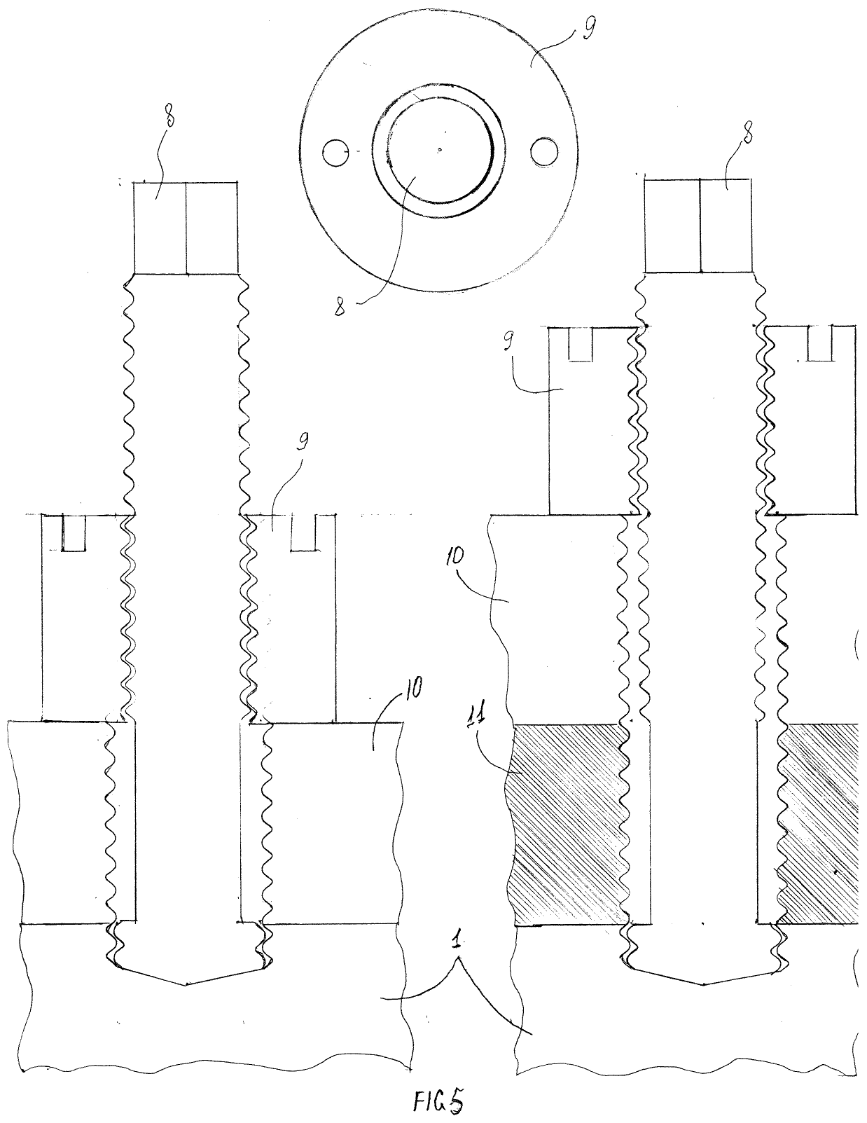

FIG. 5 offers a magnified cross-sectional view of the distraction site before and after the distraction process, including the central bolt, nut and a top view of it.

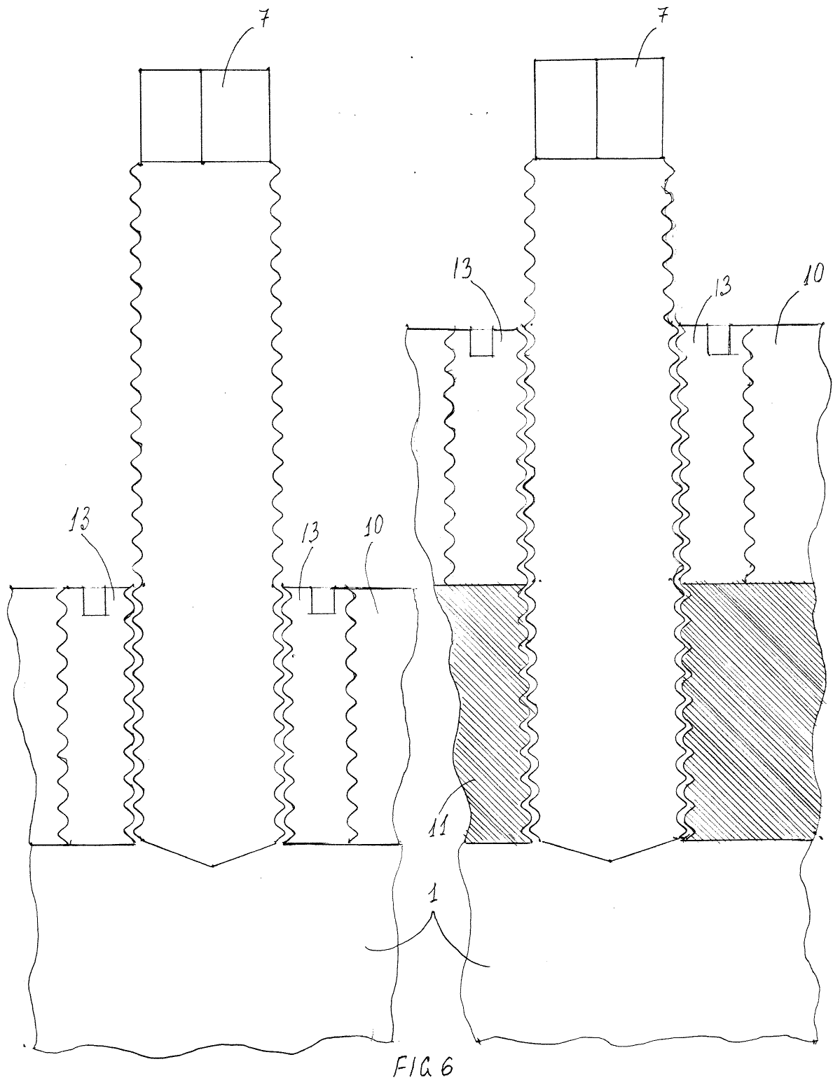

FIG. 6 illustrates a magnified cross-sectional view of the distraction site both before and after the distraction process, including the distraction bolt and a metal sleeve threaded both internally and externally, inserted into the osteotomized bone segment.

### DETAILED DESCRIPTION OF SOME EMBODIMENTS

In the following description, various aspects of the disclosure will be detailed. To provide a thorough understanding, specific configurations and details are explained. However, it will be evident to those skilled in the art that the disclosure can be practiced without these specific details. Additionally, well-known features may be omitted or simplified to avoid obscuring the disclosure. In the figures, like reference numerals refer to like parts throughout.

Different superscripts for the same reference numerals in the figures denote different embodiments of the same elements. Embodiments of the disclosed devices and systems may combine different embodiments of these elements. Specifically, a reference to an element without a superscript may refer to any alternative embodiment of the same element denoted with a superscript. Components with the same reference number followed by different lowercase letters may be collectively referred to by the reference number alone. When discussing a particular set of components, a reference number without a lowercase letter may refer to the corresponding component in the discussed set.

FIG. 1 shows a side view of the mandible bone, highlighting the atrophy on the alveolar ridge 3, the crestal osteotomy line 4, the osteotomized bone segment 10, and the predrilled threaded holes 5 and 6. After splitting the alveolar bone by creating the osteotomy line 4 and later forming the osteotomized bone segment 10, two holes 5 with diameters between 2 to 3.5 mm should be drilled through the osteotomized bone segment 10. Then, a central hole 6 should be drilled, penetrating both the osteotomized bone segment and the remaining basal bone 1 extending into the basal bone no more than 2 mm to ensure a secure connection and safety of the alveolar nerve 2. The diameter of the central hole should also be between 2 to 3.5 mm.

A significant advantage of the proposed invention is that the central hole protrudes into the basal bone only about 2 mm, in contrast to the current distraction procedures used by oral surgeons, which require at least 5 mm under the osteotomy line for distractor installation, potentially damaging the alveolar nerve. The proposed procedure avoids affecting the alveolar nerve 2. The next step is to create threads in all the holes for specific bolts.

FIG. 2 shows a side view of the mandible from FIG. 1 before distraction begins. It features two installed bolts 7, one with a right-hand thread and one with a left-hand thread, and a central bolt 8 connecting the basal bone 1 with the osteotomized bone segment 10. The two bolts 7 should be inserted up to the osteotomy line, while the central bolt 8 should extend about 2 mm into the basal bone. A nut (9) should be placed on the central bolt 8 to secure the osteotomized bone segment 4 and prevent any unintended movement. This is crucial as the osteotomized bone segment needs to move only upwards once or twice a day, approximately 0.5 to 1 mm per 24 hours, but otherwise must remain stable.

FIG. 3 shows a side view of the mandible from FIG. 2 after the distraction process is complete, with the alveolar ridge 12 lifted to the correct position to receive normal dental implants. The newly formed bone 11 is visible. All the inserted bolts 7 and 8 that constitute the distraction devices can be easily removed without a second surgery, and the holes can be used for implant installation by inserting implants with slightly larger diameters. This represents a significant improvement, as the current procedures using existing distractors require a second surgery to remove the inserted distractor.

FIG. 4 forms a magnified cross section view of the distraction site before and after the distraction process is completed, including distraction bolt and top view projection of it. The drawing presents a magnified cross section view of the osteotomy line 4, distractor bolt 7, basal bone 1, osteotomized bone segment 10, and newly formed bone 11.

FIG. 5 constitutes a magnified cross section view of the distraction site before and after the distraction process is completed, including the central bolt and top view of it. The drawing shows a magnified cross section view of the osteotomy line 4, central bolt 8, basal bone 1, osteotomized bone segment 10, adjustable nut 9, and newly formed bone 11.

FIG. 6 provides a magnified cross-sectional view of the distraction site before and after the distraction process is completed, including the distraction bolt and a metal sleeve threaded both internally and externally, inserted into the osteotomized bone segment. The drawing presents a magnified cross section view of the osteotomy line 4, distractor bolt 7, basal bone 1, osteotomized bone segment 10, double-threaded sleeve 13, and newly formed bone 11.

1. A bone tensioning distraction device, consisting of two or more distraction bolts, both right-handed and left-handed, passing through a pre-threaded osteotomized bone segment, terminating at the osteotomy line without penetrating the basal or maxilla bone, facilitating the movement of the osteotomized bone segment.

2. The distraction device of claim 1, wherein a central bolt is inserted into the osteotomized bone segment, extending partially into the basal bone or maxilla bone, temporarily securing both the osteotomized bone segment and the basal or maxilla bone in a fixed position.

3. The distraction device of claim 1, wherein a metal sleeve with internal and external threading is inserted into the osteotomized bone segment to enable the movement of the osteotomized bone segment away from the basal bone or maxilla bone when direct threading of the osteotomized bone segment is not feasible due to bone density levels.
